(19) United States
(12) Patent Application Publication
(10) Pub. No.: US 2002/0136096 A1
(43) Pub. Date: Sep. 26, 2002

(54) Wristwatch case with improved wearing comfort

(75) Inventor: Marco Mantovani, Livorno (IT)

Correspondence Address: THE FIRM OF KARL F ROSS, 5676 RIVERDALE AVENUE, PO BOX 900, RIVERDALE (BRONX), NY, 10471-0900, US

(73) Assignee: LOCMAN S.P.A.

(21) Appl. No.: 10/035,810

(22) Filed: Nov. 7, 2001

(30) Foreign Application Priority Data
Mar. 20, 2001 (WO) DM/056025

(51) Int. Cl. A44C 5/00; G04B 37/00

(52) U.S. Cl. 368/281

(57) ABSTRACT

A watch case has a circular watch body between pairs of lugs of which and between the lugs of each pair of which the body is formed with toroidal segments. One of these segments is provided centrally with a crown and, if desired, radiused buttons for operating the stop watch function of the watch works within the casing.

### FIELD OF THE INVENTION

My present invention relates to a wristwatch case affording improved comfort to the wearer, and more particularly, to a wristwatch case which is comfortable to wear and less detrimental to clothing of the wearer.

### BACKGROUND OF THE INVENTION

A wristwatch case commonly comprises a case body which has pairs of lugs by means of which a watch strap or band is affixed to the case and, projecting laterally from the case, a crown or the like enabling the setting of the watch. The back of the watch is usually flat and the face of the watch can be provided with a crystal constituting a window through which the hands and face of the watch mechanism can be viewed. While a wide variety of case configurations has been provided in the past, edges, recesses, indentations and the like have caused the watch case to seize the cuffs of the shirt or jacket of a wearer or to engage on other articles of clothing. In addition, edges and the like which have almost invariably been present in earlier watch case designs have caused discomfort on the wearer's wrist.

### OBJECTS OF THE INVENTION

It is the principal object of the present invention to provide a watch case which is free from the drawbacks of enumerated above.

Another object of this invention is to provide a watch case which is more comfortable to wear than earlier watch case configurations and yet has a reduced tendency to damage garments worn by a watch wearer.

### SUMMY OF THE INVENTION

These objects and others which will become apparent hereinafter are attained, in accordance with the invention, in a watch case which is of circular outline as viewed from the top or bottom and has lugs which extend along secants of the circular outline and which themselves terminate along circular arcs which are concentric with the outline and between these lugs, all surfaces of which are rounded and represent segments of a torus, the crown and, where appropriate, buttons for a stopwatch mechanism, projecting from one of these segments, with the buttons themselves being rounded in the form of toroidal segments.

The watch body as a whole may be curved in the longitudinal plane to conform to the configuration of the wrist of a user and the spherically convex crystal can be flush at its edges with the case and can be framed by a circular rim which merges continuously, i.e. without discontinuities, into the lugs.

### BRIEF DESCRIPTION OF THE DRAWING

The above and other objects, features, and advantages will become more readily apparent from the following description, reference being made to the accompanying drawing in which:

FIG. 1 is a top perspective view of the watch case of the present invention;

FIG. 2 is a top plan view thereof;

FIG. 3 is a bottom plan view;

FIG. 4 is a right side elevational view;

FIG. 5 is a rear elevational view;

FIG. 6 is a front elevational view;

FIG. 7 is a view similar to FIG. 1 illustrating another embodiment;

FIG. 8 is a top plan view of the second embodiment;

FIG. 9 is a bottom plan view of the second embodiment;

FIG. 10 is a right side elevational view of the second embodiment;

FIG. 11 is a rear elevational view thereof; and

FIG. 12 is a front elevational view of the second embodiment.

### SPECIFIC DESCRIPTION

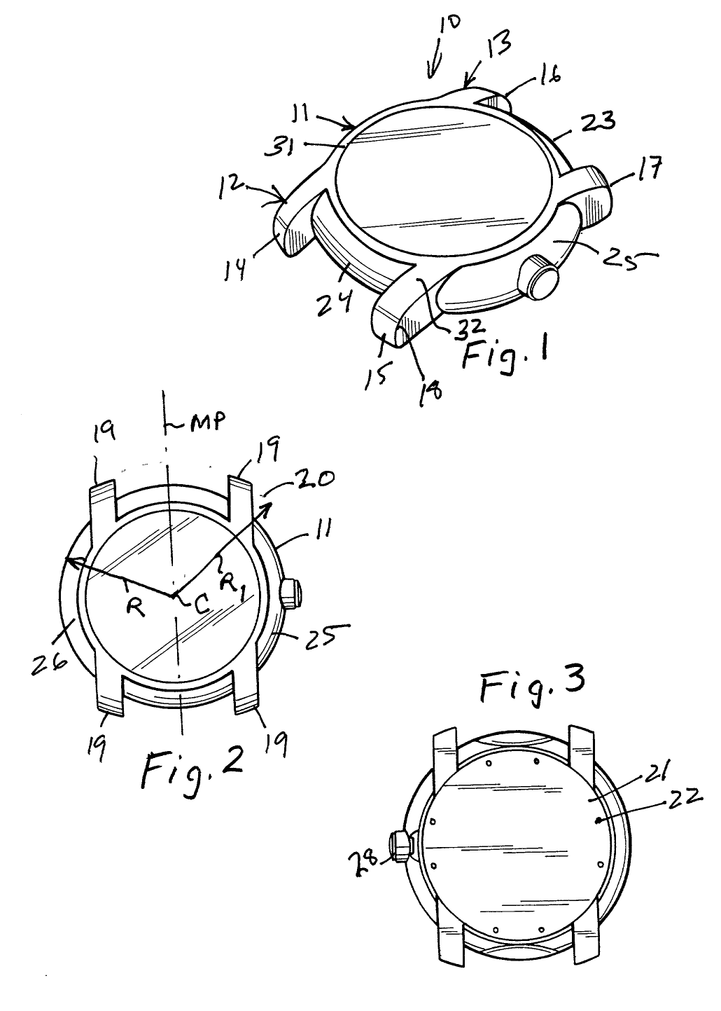

In FIGS. 1-6 of the drawing I have shown a watch case 10 which comprises a case body 11 from opposite longitudinal sides of which project pairs of lugs 12 and 13. The mutually parallel lugs 14, 15 and 16, 17 are intended to permit attachment of a strap or band of any conventional type and are radiused as shown at 18 in FIG. 1. The body 11 is itself circular with an outer radius R and the free ends 19 of the lugs (see FIG. 2) lie along a radius R₁ which is greater than the Radius R as measured from the common center C of the watch body and the emerging circular arc 20. The back 21 of the watch is substantially planar and is attached by screws 22 in a conventional manner and the body of the watch is formed with toroidal segments 23 and 24 between the lugs of each pair of segments 25 and 26 between the pairs of lugs.

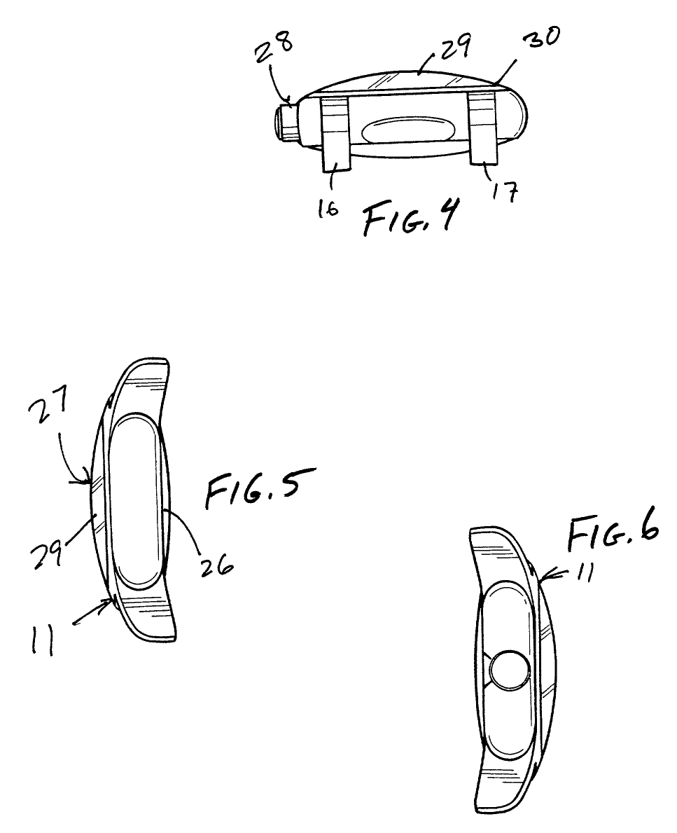

As can be seen from FIGS. 5 and 6, the body is curved in the median longitudinal plane MP so that the concave side 26 is inward and the convex side 27 is turned outwardly. The concave side 26 ensures that an inner part of the watch will conform to the concept of the wrist of the wearer. As can be seen, in addition, from FIGS. 1-4, the toroidal segment 25 is formed centrally with a crown 28 projecting laterally. The crystal 29 on the face of the watch (see especially FIGS. 4-6) conforms to a segment of a sphere and at its edge 30 merges with a frame or rim 31 of the body which extends continuously, i.e. without discontinuities at 32 into the upper surfaces of the lugs 14-17.

As a result, the segments 23-26 which are of toroidal nature in combination with the spherical crystal and the rounded surfaces of the lugs, prevent deterioration of the wearer's clothing in use and ensure comfortable wearing of the watch both with respect to the wrist of the user and any parts of the body which may be contacted by the watch.

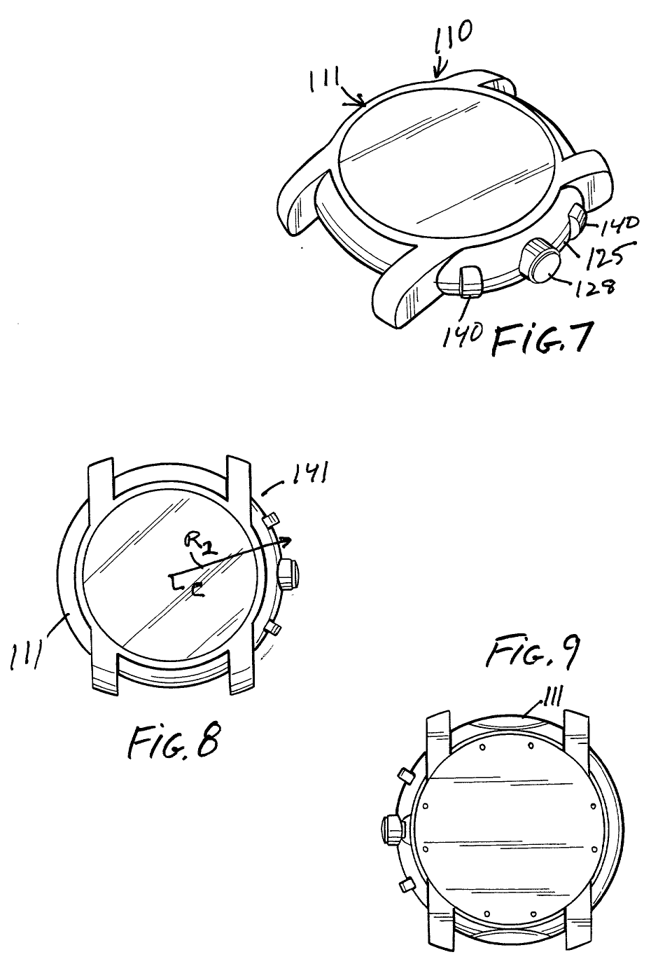

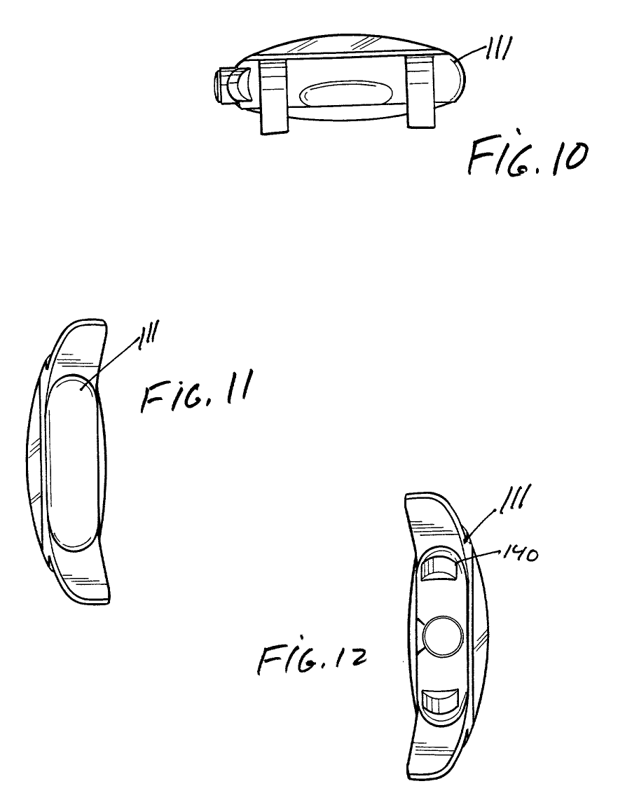

Another embodiment of the watch has shown in FIGS. 7-12, wherein the watch case 110 has the circular body 111 and the lug and toroidal arrangement of FIGS. 1-6 except that, in addition, the toroidal segment 125 is provided with a pair of buttons 140 equispaced form the crown 128 and, as can be seen from FIG. 12, radiused to conform to the outer surface of respective toroidal segments. The buttons 140 lie along a circular arc 140 at a radius R₂ between the radius R and R₁ with the same center C as the remainder of the body.

The casing of FIGS. 1-3 can have a conventional watch work (not shown) whose face and hands are visible through the crystal 29 and the casing of FIGS. 7-12 can have, correspondingly, a timer watch work whose timer functions are controlled by the buttons 140.

I claim:

1. A watch case comprising a circular watch body formed with two opposite pairs of mutually parallel transversely spaced lugs lying along secants to said body, each of said lugs having radiused free ends lying along circular arc segments concentric with said body, said body having toroidal segments between said pairs of lugs and between the lugs of each pair, said body being curved in a longitudinal median plane between the lugs of said pairs so as to have a concave curvature on a bottom side of said body adapted to conform to a wrist of a wearer and a convex curvature on a top of said body, said top of said body receiving an outwardly convex crystal conforming to a segment of a sphere and flush along an edge of said crystal with a circular frame formed on said body and merging continuously into upper surfaces of said lugs.

2. The watch case defined in claim 1, further comprising a crown projecting laterally from one of said toroidal segments centrally thereof.

3. The watch case defined in claim 2, further comprising at least one button projecting laterally from said one of said toroidal segments.

4. The watch case defined in claim 2, further comprising two buttons projecting laterally from said one of said toroidal segments and equally spaced to opposite sides of said crown, said buttons being radiused and having free extremities lying along a circular arc centered on said body.
